(19) United States
(12) Patent Application Publication
(10) Pub. No.: US 2024/0343224 A1
(43) Pub. Date: Oct. 17, 2024

(54) WIPER BLADE WITH SILICONE LIQUID RUBBER DERIVED PERMANENT COATING THEREON

(71) Applicant: Illinois Tool Works Inc., Glenview, IL (US)

(72) Inventors: Jiafu Fang, Glenview, IL (US); Guozhen Yang, Glenview, IL (US)

(73) Assignee: Illinois Tool Works Inc., Glenview, IL (US)

(21) Appl. No.: 18/621,247

(22) Filed: Mar. 29, 2024

Related U.S. Application Data
(60) Provisional application No. 63/458,700, filed on Apr. 12, 2023.

(51) Int. Cl. B60S 1/38

(52) U.S. Cl. CPC B60S 1/3848; B60S 2001/3829; B60S 2001/3898

(57) ABSTRACT

A wiper blade is provided that includes a blade having an outer surface and terminating in a lip tip. A permanent silicone outer coating derived from a liquid silicone rubber is bonded to at least to the lip tip. The coating can also encapsulate the blade. An improved process for operating a wiper blade is also provided in which the wiper blade has a blade with an outer surface and terminating in a lip tip. The improvement involves curing a liquid silicone rubber to adhere a permanent silicone outer coating at least to said lip tip and then movably contacting said lip tip with a windshield.

### RELATED APPLICATIONS

The This application is a non-provisional application that claims priority benefit of U.S. Provisional Application Ser. No. 63/458,700 filed Apr. 12, 2023; the contents of which are hereby incorporated by reference.

### FIELD OF THE INVENTION

The present invention in general relates to a wiper blade and in particular to a wiper blade having superior performance associated with a liquid silicone rubber derived permanent coating thereon.

### BACKGROUND OF THE INVENTION

Mechanical movement of a wiper blade across a windshield is partly effective as a mechanical squeegee to displace water and snow from a windshield. A conventional natural rubber or a chloroprene wiper blade while having desirable properties as to flexibility and strength undergoes degradation through exposure to the environment through exposure to heat, ozone, and ultraviolet light. While silicone wiper blades overcome many of these limitations, the expense and some disadvantageous mechanical properties has limited the use of these materials.

Thus, there exists a need for a wiper blade sheathing that adheres to the wiper blade as to allow the coated wiper blade and imparts properties to a natural or chloroprene rubber wiper blade that improves operation and longevity thereof. There further exists a need for a process of applying an inventive coating composition to a wiper blade and the operation thereof with against a contacted windshield.

### SUMMARY OF THE INVENTION

A wiper blade is provided that includes a blade having an outer surface and terminating in a lip tip. A permanent silicone outer coating derived from a liquid silicone rubber is bonded to at least to the lip tip. The coating can also encapsulate the blade.

An improved process for operating a wiper blade is also provided in which the wiper blade has a blade with an outer surface and terminating in a lip tip. The improvement involves curing a liquid silicone rubber to adhere a permanent silicone outer coating at least to said lip tip and then movably contacting said lip tip with a windshield.

### BRIEF DESCRIPTION OF THE DRAWINGS

The present invention is further detailed with respect to the following drawing. This figure is not intended to limit the scope of the present invention but rather illustrate certain attributes thereof.

FIG. 1 is a cross-sectional view of an inventive wiper blade;

FIGS. 2A-2C are optical micrographs of a comparative rubber squeegee with a graphite coating initially after formation (FIG. 2A), after 5 days in an ultraviolet (UV) chamber (FIG. 2B), and after 45 days in the UV chamber; and

FIGS. 3A-3C are optical micrographs of an inventive rubber squeegee with a graphite coating overlaid by a silicone coating initially after formation (FIG. 2A), after 5 days in an ultraviolet (UV) chamber (FIG. 2B), and after 45 days in the UV chamber.

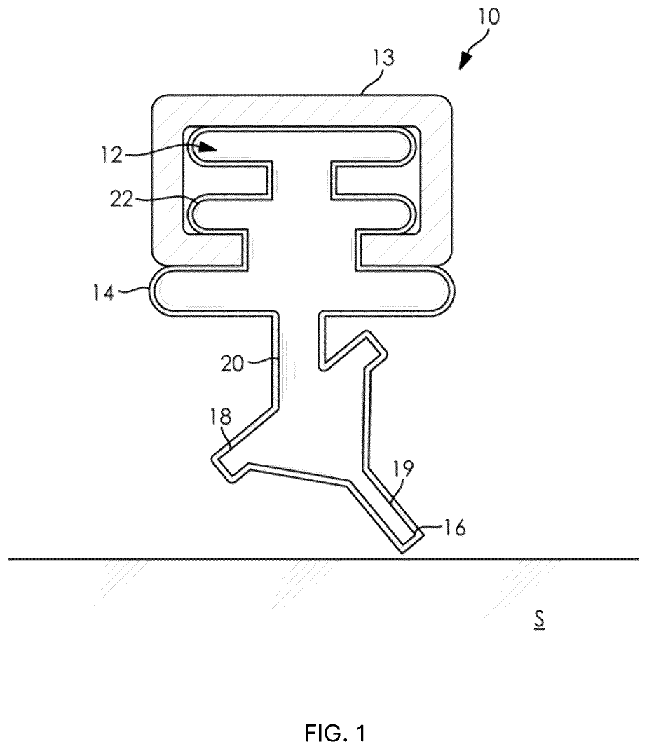

### DESCRIPTION OF THE INVENTION

The present invention has utility as a vehicle windshield wiper blade having a permanent silicone coating thereon and intended to contact a windshield substrate surface. The wiper blade has a core blade that in some in some instances is a non-silicone rubber, such as natural or chloroprene rubber. The permanent silicone coating is derived from a liquid silicone rubber precursor. While the present invention is largely detailed with respect to windshields, it is appreciated that other suitable target surfaces of usage for the present invention illustratively include manual squeegees, vehicle rear windows, aircraft exterior surfaces, and other exterior surfaces where water repellency is desired. The present invention has the attribute of long term storage stability coupled with the ability to even after storage, impart a hydrophobic film to a contacted surface. While the present invention largely details the inventive permanent coating composition on a wiper blade, it should be appreciated that an inventive coating composition is readily applied to a surface on which a hydrophobic film is desired with resort to other applicators illustratively including a buffing pad, brush, dip, or spray gun. An inventive silicone outer coating renders a conventional non-silicone wiper blade superior in terms of both substrate clearing and operational longevity.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

Unless indicated otherwise, explicitly or by context, the following terms are used herein as set forth below.

As used in the description of the invention and the appended claims, the singular forms “a,” “an” and “the” are intended to include the plural forms as well, unless the context clearly indicates otherwise.

Also as used herein, “and/or” refers to and encompasses any and all possible combinations of one or more of the associated listed items, as well as the lack of combinations when interpreted in the alternative (“or”).

The blade overcoated according to the present invention is defined herein to include those formed of natural rubber, chloroprene rubber, of even silicone rubber, with the proviso that the silicone rubber of the blade is compositional different than that applied through overcoating.

Referring now to the Figure, an inventive wiper blade is shown generally at 10 that includes a blade 12. The blade 12 has a permanent silicone outer coating 14 derived from a liquid silicone rubber is applied and bonded at least to the lip tip 16 of the blade 12. The permanent silicone outer coating 14 on the lip tip 16 is adapted to contact a windshield substrate, In still other inventive embodiments, the permanent silicone outer coating 14 encapsulates the blade 12 and covers other portions of the outer surface 18 of the blade 12. In still other embodiments, the lip tip 16 and at least one portion of the blade 12 are coating including lip sides 19, a neck 20, a head portion 22, or a combination thereof. It is appreciated that conventional masking techniques are readily employed in those inventive embodiments in which the permanent silicone outer coating 14 is desired on specific portions of a blade 12. The permanent silicone outer coating 14 is applied to the blade 12 using any desired process that allows the desired thickness (t) of the permanent silicone outer coating 14 to be attained. The thickness, t, is generally between 0.05 and 3 mm, and still other embodiments between 0.1 and 0.3 mm. A support arm 13 is provided that mounts the wiper blade 10 to the vehicle and in slidable proximity to a target substate such as a windshield.

When the permanent silicone outer coating 14 is provided within the aforementioned range of thickness t, flexibility and conformability of the tip lip 16 is improved as evidenced by reduced chatter and friction as the wiper blade 10 moves across the windshield substrate. An inventive wiper blade 10 is also noted to suffer slower environmental degradation, as compared to a like wiper 16 lacking the permanent silicone outer coating. Sources of environmental degradation illustratively including ozone, sunlight, and temperature extremes encountered by a conventional land vehicle.

It has been surprisingly discovered that a permanent silicone outer coating 14 applied and bonded to a blade 12 from a liquid silicone rubber is superior to that applied from a silicone gel precursor, a polytetrafluoroethylene. Without intending to be bound to a particular theory, the permanent silicone outer coating 14 derived from a liquid silicone penetrates the surface of the wiper 12 to create mechanical adhesion; additionally, residual reactive sites on the wiper 12 may react with the liquid silicone precursors.

In some inventive embodiments, the wiper 12 is exposed to a gamma ray, UV-ozone, microwaves, and plasma prior to exposure to the liquid silicone precursor to activate the surface thereof in terms of creating additional bonding sites thereon which can react with the liquid silicone. The operation of these techniques are well-known in the art. C. Makoundou et al. Recycling 2021, 6 (1), 19. While plasma is readily generated at a variety of pressures from 0.00001 to 1 atmosphere (atm). Surface activation of the blade 12 occurs at temperatures as low as 20° C. Typically, surface activation temperatures range from 20-250° C.

Plasma generation occurs in a variety of gases, with the choice of gas being dictated by the type of surface activation desired. By way of example, processes requiring ion bombardment as a primary mechanism, such as reactive ion etching, the power density to the plasma, expressed in units of Watts per cubic centimeter per kilopascal (kPa) of pressure, are higher than for processes where neutral species only are required, such as deposition of oxygen species. Typically, ion-based processes have power densities that are roughly between about 3 and 100 W/cm3/kPa, while neutral-based processes have densities between about 0.1 and about 10 W/cm3/kPa.

Conventional wiper blade materials are amenable to formation of increased oxygen reactive moieties of hydroxyl, single oxygen, and peroxides; air or di-oxygen gas based plasmas are well suited for increasing reactive sites on a wiper 12. Ion bombardment induced activation is readily performed with inert gases such as nitrogen, neon, or argon. In some inventive embodiments, a chemical vapor deposition (CVD) precursor is added to the gas to add specific functionality to the surfaces of the blade 12. It is appreciated that conventional masking techniques are readily employed in those inventive embodiments in which enhanced activation is desired on specific portions of a blade 12.

The permanent silicone outer coating 14 is derived from a layer-forming coating liquid containing a liquid silicone rubber that is cured by heating to become the permanent silicone outer coating 14. The resulting elastic layer-forming coating liquid is applied onto the blade 12 to form a coating film, and as needed, the coating film is vulcanized to form the permanent silicone outer coating 14 on the blade 12. In the vulcanization of the coating film, the vulcanization temperature ranges from 110° C. to 250° C. for vulcanization times of from 3 to 120 minutes.

The silicone rubber of the permanent silicone outer coating 14 imparts heat and weather resistance, water repellence, softness, cohesion, flexibility, to the wiper 12. A conventional liquid silicone rubber coating composition operative herein from which the permanent silicone outer coating 14 is formed includes an organopolysiloxane containing at least two silicon bonded alkenyl radicals per molecule, an organohydrogen polysiloxane containing Si—H radicals, an addition reaction catalyst, an organosilicon compound containing epoxy and alkoxy radicals, and an optional adhesion promoter such as a silanol-containing silane or siloxane compound pre-coating an outer surface 18 of the blade 12 and cured to form the permanent silicone outer coating 14. Additional details of these components are found in EP2009059. It should be appreciated that plasma or flame activation of blade 12 diminishes the need for a chemical adhesion promoter.

Another conventional liquid silicone rubber coating composition operative herein from which the permanent silicone outer coating 14 is formed includes the addition reaction of linear siloxanes containing at least two reactive moieties per molecule with allylamines. The degree of branchingbeing easily controlled with using a mixture of diallylamines and polyallylamines. Lyashenko, I. N., Nametkin, N. S. & Chernysheva, T. I. Addition reactions of linear siloxanes to allylamine. Russ Chem Bull 18, 1034-1036 (1969).

An inventive coating composition includes a two-part formulation with both parts being liquids at 20° C.

An organopolysiloxane which has at least two alkenyl radicals bonded to silicon atoms per molecule is provided. In some inventive embodiments, the organopolysiloxane is substantially free of silicon-bonded hydroxyl radicals pendent or terminal therefrom.

An organopolysiloxanes having the average compositional formula (I) and is linear, cyclic, or branched:

R¹ₙR²ₘSiO_{(4-(m+n))/2} (I)

wherein each R¹ in each occurrence is a substituted or unsubstituted alkyl C₁₋₁₂ or C₆₋₁₂ aryls, wherein each R² in each occurrence is a substituted or unsubstituted alkenyl C₁₋₁₂, and n+ m are a number between 1.3 to 2.9. Exemplary reactive groups, R² illustratively include epoxide, amine, anhydride, acrylate, isocyanate, hydroxyl, thiol, vinyl, allyl, butenyl, pentenyl, hexenyl and heptenyl. R² groups are either pendant or terminal relative to the backbone. It is appreciated that the higher the crosslink density, n, the more rigid the resulting cured silicone coating 14.

R¹ groups in formula (I) illustratively include unsubstituted or halogen-substituted groups of methyl, ethyl, propyl, butyl, pentyl, hexyl, cyclohexyl, heptyl, phenyl, tolyl, xylyl, naphthyl, benzyl, phenethyl, chloromethyl, 3-chloropropyl and 3,3,3-trifluoropropyl. The content of R² in (I) is between 0.001 to 10 mol percent of all the monovalent organic radicals bonded to silicon atoms. It is appreciated that the higher the crosslink density, n, the more rigid the resulting cured silicone coating 14.

The organopolysiloxane of formuala (I) has a viscosity at 25° C. of from 50 to 500,000 centiPoise (cP), as measured by rotational viscometry with a 4 L spindle.

Exemplary organopolysiloxanes of formula (I) operative herein illustratively include trimethylsiloxy-endcapped dimethylsiloxane-methylvinylsiloxane copolymers, trimethylsiloxy-endcapped methylvinylpolysiloxanes, trimethylsiloxy-endcapped dimethylsiloxane-methylvinylsiloxane-methylphenylsiloxane copolymers, dimethylvinylsiloxy-endcapped dimethylpolysiloxanes, dimethylvinylsiloxy-endcapped methylvinylpolysiloxanes, dimethylvinylsiloxy-endcapped dimethylsiloxane-methylvinylsiloxane copolymers, dimethylvinylsiloxy-endcapped dimethylsiloxane-methylvinylsiloxane-methylphenylsiloxane copolymers, divinylmethylsiloxy-endcapped dimethylpolysiloxanes, divinylmethylsiloxy-endcapped dimethylsiloxane-methylvinylsiloxane copolymers, trivinylsiloxy-endcapped dimethylpolysiloxanes, trivinylsiloxy-endcapped dimethylsiloxane-methylvinylsiloxane copolymers, and combinations thereof.

The organopolysiloxanes of formula (I) reacts with an organohydrogenpolysiloxane that functions as a crosslinking agent. It is appreciated that the organohydrogenpolysiloxane should have on the molecule at least two hydrosilyl groups per molecule and typically has from 2 to 300 such groups per molecule. It is appreciated that silanol groups therein complicated crosslinking reactions. The organohydrogenpolysiloxane typically has a viscosity similar to the that of the organopolysiloxanes of formula (I) as measured by the same technique as detailed above.

Organohydrogenpolysiloxanes operative herein illustratively include 1,1,3,3-tetramethyldisiloxane, 1,3,5,7-tetramethylcyclotetrasiloxane, tris(hydrogendimethylsiloxy)methylsilane, tris(hydrogendimethylsiloxy)phenylsilane, methylhydrogencyclopolysiloxane, methylhydrogensiloxane-dimethylsiloxane cyclic copolymers, trimethylsiloxy-endcapped methylhydrogenpolysiloxanes, trimethylsiloxy-endcapped dimethylsiloxane-methylhydrogensiloxane copolymers, trimethylsiloxy-endcapped dimethylsiloxane-methylhydrogensiloxane-methylphenylsiloxane copolymers, trimethylsiloxy-endcapped dimethylsiloxane-methylhydrogensiloxane-diphenylsiloxane copolymers, dimethylhydrogensiloxy-endcapped methylhydrogenpolysiloxanes, dimethylhydrogensiloxy-endcapped dimethylpolysiloxanes, dimethylhydrogensiloxy-endcapped dimethylsiloxane-methylhydrogensiloxane copolymers, dimethylhydrogensiloxy-endcapped dimethylsiloxane-methylphenylsiloxane copolymers, dimethylhydrogensiloxy-endcapped dimethylsiloxane-diphenylsiloxane copolymers, dimethylhydrogensiloxy-endcapped methylphenylpolysiloxanes, dimethylhydrogensiloxy-endcapped diphenylpolysiloxanes, and combinations thereof.

While the molecular ratio of organohydrogenpolysiloxane Si—H groups to reactive groups R² are a matter of routine experimentation, typically Si—H groups are present in molar excess to assure complete cure.

In some inventive embodiments, an optional addition reaction catalyst is provided to promote the addition reaction between R² and Si—H groups. Exemplary addition catalysts operative herein include platinum, palladium, rhodium, and organometallics containing these metals. These illustratively include chloroplatinic acid, alcohol-modified chloroplatinic acid, coordination compounds of chloroplatinic acid with olefins, vinylsiloxane or acetylene compounds, tetrakis(triphenylphosphine) palladium, chlorotris(triphenylphosphine) rhodium, and the like. The addition reaction catalyst, if present is typically present upon mixing both parts of the liquid silicone is present in an amount of 0.5 to 1,000 ppm as measured as the weight of catalyst metal element in the fully formulated and just mixed silicone forming composition.

In some inventive embodiments, a filler is present in an inventive coating and can improve the toughness and durability of the coatings. Fillers operative herein include silicas, carbon blacks and the mixtures thereof. Typical loadings of filler particles in a resulting coating, if present, are between 0.1 to 2 coating weight percent.

In some inventive embodiments, a silicone oil, or a silicone oil in combination with a particulate lubricant is present in the coating and thereby transferred onto a contacting windshield through the friction of the wiper blade against the windshield. Specific silicone oils operative herein illustratively include polydimethylsiloxane, decamethylcyclopentasiloxane, methylphenylpolysiloxane, methylhydrogenpolysiloxane, amino-functional polydimethylsiloxane, octamethyltrisiloxane, decamethyltetrasiloxane, carboxyl-functional polydimethylsiloxane, carbinol-functional polydimethylsiloxane, phenol-functional polydimethylsiloxane, fluoro-functional polydimethylsiloxane, epoxy-functional polydimethylsiloxane, alkyl-functional polydimethylsiloxane, polyether-functional polydimethylsiloxane, and combinations thereof. Typical loadings of silicone oil in a resulting coating, if present, is present between 0.1 to 5 coating weight percent. A particulate lubricant operative in the present invention illustratively includes graphite, turbostratic carbon, boron nitride, boric acid, polytetrafluoroethylene (PTFE), molybdenum disulfide (MoS2), synthetic polymeric materials, and combinations thereof. Typical loadings of a particulate lubricant in a resulting coating, if present, is present between 0.1 to 2 coating weight percent.

An inventive coating composition includes a solvent or a combination of solvents capable of forming a solution with a silicone oil and resin components of an inventive coating composition. The solvents operative herein illustratively include solvents suitable for dissolution of the silicone oil and resin operative illustratively include methylethylketone C₁-C₈ alkyl lactates, toluene, xylene, C₁-C₈ alkyl benzenes, C₁-C₈ alkyl acetates, C₂-C₈ alcohols, as well as combinations thereof. It is appreciated that the term “alkyl” is used herein is intended to include linear, branched, and cyclic forms thereof. The nature of the solvent as operative herein is largely limited only to the ability to dissolve the silicone oil and the resin components. As will be made clear from the following description, as the inventive composition is applied to an wiper in the controlled environment, solvent evaporation to form a a cured silicone coating adhered to the blade, in such embodiments the solvent is amenable to capture and in specific embodiments to recycle. In still another embodiment of an inventive coating composition contains no solvent; and liquids cure to form the silicone coating.

An inventive coating composition in some inventive embodiments includes a particulate lubricant. A particulate lubricant according to the present invention is either applied separately to a resulting permanent silicone outer coating 14 or as a colloidal dispersion in the solvent along with the precursors therefor. The particulate lubricant in certain embodiments of the present invention has greater than 90 particle number percent of the particulate having a particle size smaller than 100 microns as determined by size guide number (SGN). In still other embodiments of the present invention, 100 particle number percent are smaller than 100 microns. In still other embodiments of the present invention, the particulate has a mean particle size smaller than 50 microns. In certain embodiments of the present invention, a coating composition in solvated form is 0.5 to 30 total weight percent particulate lubricant and from 1 to 60 weight percent after the composition is dried to a nonvolatile form on an applicator or if no solvent is used. A particulate lubricant operative in the present invention illustratively includes graphite, turbostratic carbon, boron nitride, boric acid, polytetrafluoroethylene (PTFE), molybdenum disulfide (MoS₂), synthetic polymeric materials, and combinations thereof.

An inventive coating composition upon being fully mixture of parts A and B and from which the permanent coating is derived is summarized in Table 1.

TABLE 1
Inventive coating composition formulation
and layer formed therefrom.

| | Solvated | Non-volatile |
|---|---|---|
| Component | total wt % | total wt. % |
| Organopolysiloxanes of formula (I) | 0.1-70 | 1-80 |
| Organohydrogenpolysiloxane | 0.1-70 | 1-80 |
| Addition reaction catalyst | 0.01-2 | 0.1-5 |
| Particulate lubricant | 0.1-45 | 0.5-50 |
| Solvent | 0-remainder | trace to nil |

A process for operating a wiper blade according to certain embodiments of the present invention is achieved by wiping the windshield under wet, dry, or a combination of wet and dry conditions. The ability to wipe water from the windshield with an inventive wiper blade with the permanent silicone coating is superior to that for an uncoated wipe blade otherwise identical to said wiper blade. Water wipe ability being a measure of water displacement in a wipe cycle as determined by the windshield wiped area showing streaks or pools.

### EXAMPLES

These examples demonstrate the processes to be claimed in this patent filing. It should be remarked that other additions and modifications as known in the art are also expected to be covered.

### Example 1

The coatings compose of 20 total weight percent of a waterborne, elastomeric organopolysiloxanes emulsion, 29 total weight percent of water, 50 total weight percent of graphene slurry, 0.5 total weight percent of wetting agent, 0.5 total weight percent of defoamer.

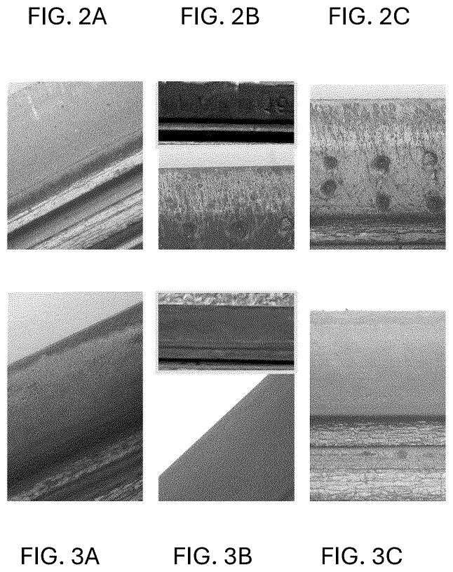

The appearance of the squeegee surface is pictured under optical microscopy with a comparative example of a rubber squeegee with a graphite coating (FIGS. 2A-2C) relative to the present invention with a silicone overlying coating (FIGS. 3A-3C). The results of FIGS. 3A-3C indicate that the permanent silicone outer coating (shown here as a top coating) protects the graphite coating (base coating) for 45 days in UV chamber (FIG. 3C), while the graphite coating (base coating) without the permanent silicone outer coating (top coating) degraded significantly within 5 days in UV chamber (FIG. 2B). In conclusion, the squeegee with a permanent silicone overlying coating is more weatherable under UV.

Patents and publications mention the specification are indicative of the levels of those skilled in the art to which the invention pertains. These patents and publications are incorporated herein by reference to the same extent as if each individual patent or publication is specifically and individually incorporated herein by reference.

The forgoing description is illustrative of particular embodiments of the invention, but is not meant to be a limitation upon the practice thereof. The following claims, including all equivalents thereof are intended to define the scope of the invention.

1. A wiper blade comprising:
a blade having an outer surface and terminating in a lip tip; and
a permanent silicone outer coating derived from a liquid silicone rubber bonded to at least to the lip tip.

2. The wiper blade of claim 1 wherein said blade is formed of natural rubber.

3. The wiper blade of claim 1 wherein said blade is formed of chloroprene rubber.

4. The wiper blade of claim 1 wherein said blade is formed of a silicone rubber compositionally distinct from said permanent silicone outer coating.

5. The wiper blade of claim 1 wherein said permanent silicone outer coating encapsulates said blade.

6. The wiper blade of claim 1 wherein said permanent silicone outer coating covers at least one portion of the outer surface of said blade.

7. The wiper blade of claim 6 wherein the at least one portion of the outer surface of said blade is a lip side, a neck, a head portion, or a combination thereof.

8. The wiper blade of claim 1 wherein said permanent silicone outer coating has a thickness of between 0.05 and 3 millimeters.

9. The wiper blade of claim 1 further comprising particulate filler embedded in said permanent silicone outer coating.

10. The wiper blade of claim 9 wherein said particulate is a lubricating particulate of graphite, turbostratic carbon, boron nitride, boric acid, polytetrafluoroethylene (PTFE), molybdenum disulfide (MoS₂), synthetic polymeric materials, and combinations thereof.

11. The wiper blade of claim 1 further comprising residual solvent from said liquid silicone composition.

12. The wiper blade of claim 1 further comprising a silicone oil, alone or in combination with a lubricant particulate.

13. An improved process for operating a wiper blade, the wiper blade having a blade with an outer surface and terminating in a lip tip wherein the improvement lies in: curing a liquid silicone rubber to adhere a permanent silicone outer coating at least to said lip tip; and movably contacting said lip tip with a windshield.

14. The improved process of claim 13 wherein the outer surface is masked to adhere said permanent silicone outer coating to less than all of the outer surface.

15. The improved process of claim 13 further comprising embedding particulate in or on said permanent silicone outer coating.

16. The improved process of claim 13 further comprising plasma or flame treating said wiper prior to said curing.
